(19) United States
(12) Patent Application Publication
(10) Pub. No.: US 2010/0257009 A1
(43) Pub. Date: Oct. 7, 2010

(54) SERVICE ORIENTATED COMPUTER SYSTEM WITH MULTIPLE QUALITY OF SERVICE CONTROLS

(75) Inventors: Yan Liu, Randwick (AU); Minan Tan, Macquarie Park (AU)

Correspondence Address: SNELL & WILMER LLP (OC), 600 ANTON BOULEVARD, SUITE 1400, COSTA MESA, CA, 92626, US

(73) Assignee: NATIONAL ICT AUSTRALIA LIMITED, Eveleigh (AU)

(21) Appl. No.: 12/416,730

(22) Filed: Apr. 1, 2009

(51) Int. Cl. G06Q 10/00

(52) U.S. Cl. 705/8; 705/7

(57) ABSTRACT

The invention concerns service orientated computer system comprised of services, such as web services, connected by an event-driven middleware. In particular, the invention concerns adaptive and self-managing systems that can adapt their behaviour based on components that monitor the behaviour of the system and provide feedback. The system attempts to meet a quality of service based on multiple quality controls 26, 70, 72 where each quality control 26 is associated with one or more components 24. The controls 26 receive input messages from associated components 24 and execute 22 a process model 20 associated with the quality control 26 based on the received messages to send messages to the one or more associated components 24 to change the behaviour of the components 24. Communication between all components 24 is performed by sending and receiving messages. The controls 26 define the logic for the sending of these messages that in turn change the behaviour of the system. The controls 26 provide a layer of abstraction that allows loose coupling between the controls 26 and components 24. This avoids the disadvantages associated with hard coding of logic within components 24. Aspects of the invention include a computer system, method, and software.

### TECHNICAL FIELD

The invention concerns service orientated computer system comprised of services, such as web services, connected by an event-driven middleware. In particular, the invention concerns adaptive and self-managing systems that can adapt their behaviour based on components that monitor the behaviour of the system and provide feedback. Aspects of the invention include a computer system, method, and software.

### BACKGROUND ART

As Service Oriented Architecture (SOA) becomes more widely adopted in large software systems, the typical SOA environment has become more complex. Management of these increasingly complex environments is exacerbated by crosscutting components and services as well as overlapping SOA environments with service providers beyond the administrator's control. While some human inspection or administration tools can and should be provided, it is unrealistic to expect that all configurations and management can be effectively handled manually. Being fully dependent on manual controls would void the improvements in timeliness and adaptivity gained with an increased level of automation. Consequently, incorporating adaptive and self-managing capabilities into services [4,15] is attracting considerable attention as a means to respond to both the functional and environmental changes that occur after service deployment.

In principle, a system exhibiting adaptive and self-managing capabilities [7,11,12] consists of two parts: (1) a base system that implements the business logic and provides concrete functionalities; and (2) a set of controls that comprise control components for constantly monitoring the system, analyzing the situation and deciding on the actions to affect the system's behaviour. When the base system is composed of services in a SOA, the addition of these control components results in adaptive and self-managing service-oriented systems.

In practice, individual control components are dedicated to a specific quality attribute, such as load balancing for performance and scalability or failover for reliability. These are normally constructed independently.

As an example of a SOA, consider the loan brokering application in [6], where a customer submits requests for a loan quote to a loan broker. The loan broker checks the credit worthiness of a customer using a credit agency. The request is then routed to appropriate banks who each give a quote, and the lowest quote is returned to the customer. This application has been deployed (see left of FIG. 1) over an Enterprise Service Bus (ESB) with messaging capabilities provided by Java Messaging Services (JMS), bringing together Web Services, Plain Old Java Objects (POJO) and remote Enterprise Java Beans (EJB). Event flow is driven by the arrival of events. In this application as described in [6], there are two scenarios concerned with adaptive and self-managing controls: (1) failover and (2) overload.

Suppose the responsiveness to requests of the credit agency is in question, and the administrator wants to allow a graceful fail over to an alternative credit agency should the primary agency fail. One solution is to insert an additional switching component between the loan broker and the credit agency that can reroute traffic to an alternative credit agency (see FIG. 1). In this solution, a test message sensor constantly sends test messages to the credit agency to ensure its correct operation. A notification message is sent to the switch to reroute traffic to a backup credit agency if the test message fails. This forms a feedback control between the test message sensor (feedback) and the switch (control). It is worth noting that this failover occurs at the service level: the primary and secondary services can be from different service providers across the organization boundary. Failures at this level cannot be addressed with system level solutions, such as clustering, and need to be explicitly dealt with at a higher level.

In addition to ensuring the robustness of the credit agency, the administrator also wishes to prevent the loan broker from becoming saturated with requests. As shown in the right of FIG. 1, a throttling component can be used to regulate the flow of requests by limiting the number of concurrent requests being processed. A traffic flow sensor is also used in this situation to detect the flow rate. Beyond the threshold of the system's computing capacity, higher flow rates reduce the number of concurrent processes handling requests and vice versa.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

In a first aspect the invention provides a service orientated computer system comprised of services connected by an event-driven message based middleware, the middleware further comprising:
multiple components that function to sense messages and effect delivery of messages within the middleware and between services;
a set of controls to automatically change the behaviour of the system to meet a quality of service, the set of controls comprising:
   multiple quality controls each directed to one or more quality of service metrics and associated with one or more components, where each quality control is modelled as an executable process model that receives input messages from one or more associated components and, based on the received messages and the executable process model, operates to automatically send messages to the one or more associated components to change the behaviour of the one or more associated components; and
a process engine to execute the executable process models of the controls.

Communication between all components is performed by sending and receiving messages. The controls define the logic for the sending of these messages that in turn change the behaviour of the system. The controls provide a layer of abstraction that allows loose coupling between the controls and components. This avoids the disadvantages associated with hard coding of logic within components.

The model of the quality control may be comprised of states and transitions having associated action code that when executed by the process engine changes the behaviour of the one or more associated components.

One or more components may have control parameters. The message may alter a control parameter of a component. This may be done by altering a configuration file associated with the component.

The set of controls may further comprise:
one or more coordinating controls that are associated with one or more quality controls, where each coordinating control is modelled as an executable process model to automatically coordinate dependencies between the two or more associated quality controls.

The coordinating controls may receive status messages from each of the associated quality controls and coordinates dependencies between the associated quality controls based on the received status messages and executable process model. The status messages may be received by an aggregation sensor component of the coordination control.

The coordination control may operate to change the behaviour of the system by sending a message to a component associated with a quality control that is in turn associated with the coordination control in order to change the behaviour of the one or more associated components.

A message sent from a coordination control to a component has precedence over a message sent from a quality control to the same component.

Coordination and quality controls can be updated, deployed or undeployed at runtime

A first quality control may be directed to overloading as the quality of service metric. A second quality control may be directed to failover as the quality of service metric.

The coordinating control may be associated with the first and second quality control. The coordinating control may receive the status message from the second quality control indicating that overload has occurred. The coordinating control coordinates the dependency by sending a message to a component associated with the overload control to cause the slowing down the acceptance rate of new requests to a service until the failover operations complete.

Changing the behaviour of the one or more associated components may be performed at runtime.

The change in the behaviour of one or more components may result in one or more of:
redirecting messages between services,
deploying or replacing of services
pausing or resuming of a service,
intercepting messages, or
modifying messages.

The components may be sensors, routers, throttlers and/or multicasters.

The models are in business process modelling (BPM) language.

Each coordinating control represents a unique cross cutting concern of the associated quality controls.

The services are spread across multiple organization boundaries. The components, controls and processing engine are deployed at service boundary rather than within services.

The event-driven middleware may include an Enterprise Service Bus (ESB). The services may be hosted on a distributed computer network or on Internet. The middleware may also be distributed to any host. Each host may be a web server or a platform that hosts services, such as Cloud computing infrastructure.

Services may be web based, and may be accessed by a unique identity (called endpoint).

In a further aspect the invention provides a method of automatically changing the behaviour a service orientated computer system comprised of services connected by an event-driven message based middleware to meet a quality of service, the method comprising executing at run time multiple quality controls, each quality control directed to one or more quality of service metrics and associated with one or more components that function to sense messages and effect delivery of messages within the middleware and between services, by for each quality control:
receiving input messages from one or more associated components;
executing a process model associated with the quality control based on the received messages to send messages to one or more associated components to change the behaviour of the components.

The method may further comprise the steps of the quality controls sending status messages and executing at run time coordinating controls that automatically coordinate dependencies between two or more associated quality controls, by for each coordinating control:
receiving the status messages from the one or more associated quality controls;
executing a process model associated with the coordinating control based on the received status messages to send messages to one or more associated components of the associated quality controls to change the behaviour of the components.

In yet a further aspect the invention provides software, that is computer executable instructions stored on a computer readable medium, that when installed causes a computer system to operate in accordance with the method described above.

The invention includes the realisation that control components need to be coordinated at runtime to resolve their dependencies that are incurred by cross-cutting concerns. For example, the operation to switch to a backup service may come at a cost of performance by degrading the throughput over a given period of time.

While component-based development helps to modularize and encapsulate adaptive and self-managing computation, there is still tight logical coupling and interdependencies between control components. Examples of such tight coupling include systems where the monitoring, analysis and configuration control components explicitly invoke one another without the intervening layer of abstraction. The aim of the invention is to abstract the controls and their dependencies so that their actual implementation is separated from the control logic.

### BRIEF DESCRIPTION OF THE DRAWINGS

FIG. 1 is a known schematic representation of an example of a known loan brokering service orientated computer system.

An non-limiting example of the invention will now be described with reference to the accompanying drawings, in which:

FIG. 2(a) is a simplified representation of the architecture of this example, and

FIG. 2(b) shows the same architecture when customized for specific controls.

FIG. 3 shows a sample graphical user interface (GUI) for designing a control model and attaching action code to it where the GUI tool is from JBoss jBPM is utilized [8];

FIG. 4 shows sample code for changing control parameters of a component;

FIG. 5 schematically shows the system architecture before and after overload control deployment; (without coordination)

FIG. 6 schematically shows the system architecture before and after failover control deployment (without coordination);

FIG. 7(a) schematically shows the overload and failover control when coordinated, and FIG. 7(b) shows;

FIG. 8 is an example flowchart showing the steps of this example of the invention; and

FIGS. 9 to 12 are sample user interfaces displaying sample performance measurements from testing scenarios.

### BEST MODES OF THE INVENTION

An example of the invention and its evaluation will now be described.

In this example, to support ease of service evolution, the composition of control components with existing services is transparent to business logic. That is, the control logic does not require modification of the original service operation.

However, in a component based implementation of the controls, flexibility is reduced as the control logic would be embedded in the components. For example, if the criteria to trigger the failover switch is changed, a rewrite of the basic switching and test message components would be required to coordinate their logic.

Moreover, introducing control components also creates dependencies between the business and management flows. For example, the loan broker needs to be aware of the switching component in order to send messages correctly to the switch and not to the credit agency. As more management controls are added, the introduced dependencies both obscure the original business flow as well as reduce the system's flexibility to changes in both flow types.

Accordingly, the following example meets the following architectural requirements:
(1) represent, execute and coordinate multiple adaptive and self-managing controls;
(2) seamless integration of controls, middleware and service business logic;
(3) controls can be composed, modified and deployed at runtime; and
(4) the solution should be lightweight, otherwise it could adversely degrade overall performance and scalability.

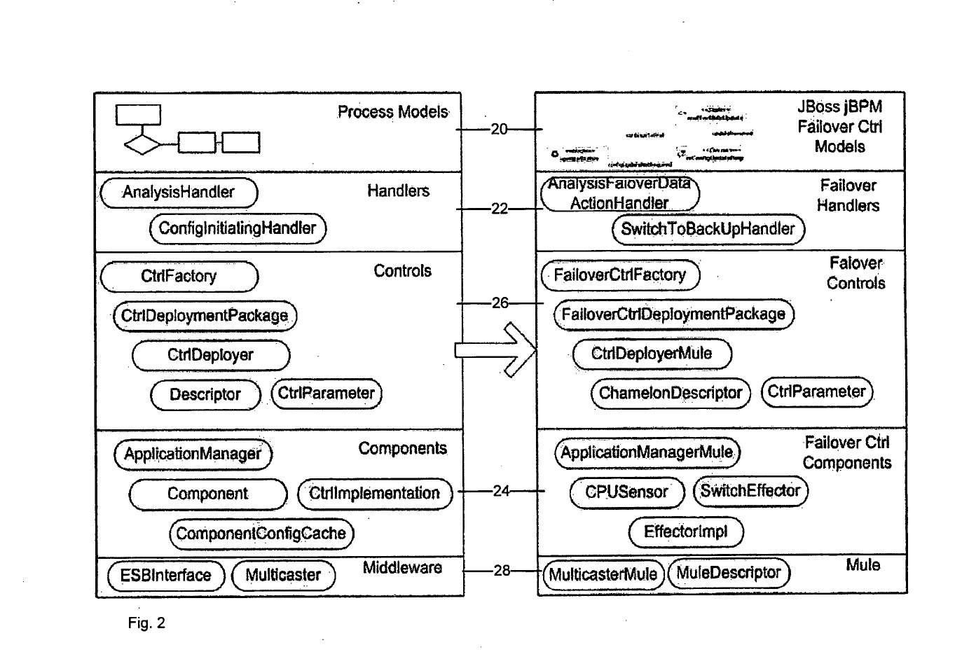

Conceptually, the architecture of this example has five layers. The left of FIG. 2 demonstrates a simplified general architecture with only core components, not specific to any control logic or middleware. The right of FIG. 2 illustrates the customization of the architecture components to specific controls.

The architecture framework provides a modelling based approach towards coordinating multiple controls in service-oriented systems. Adaptive and self-managing controls follow logic that transitions the system from one state into another in response to events dynamically generated at runtime. In addition, the logic represented by the models needs to be executed as well. Given this consideration, we use process models as the tool to present and execute controls. The use of process models is motivated by their rich semantics, alignment with business goals, integration with Web services and tool support for visual design. The process models can also be executed by process engines with middleware integration features, such as the Oracle BPM engine and JBoss jBPM. Here, the term control model is used to refer to a process model designed and executed in a similar way to the JBoss jBPM technology [8].

Referring to FIG. 2, at the top layer, the control models 20 are firstly designed in diagrams. A model includes nodes for states and transitions triggered by events. Furthermore, these control models are not only for the purposes of presentation, but can be executed. Source code called actions can be attached to either states or transitions of the model.

The layer below the control models comprises handlers 22 that encapsulate the action code. Upon entering/leaving a state or before/after triggering a transition, the process engine checks and executes the handler for actions. Our architecture has default implementations for two handlers, AnalysisHandler and ConfigInitialisingHandler, which are responsible for managing dependencies between control models, and checking a data cache for individual control components respectively. Their usage is addressed further below. The combination of these two layers focus on architecture requirement (1).

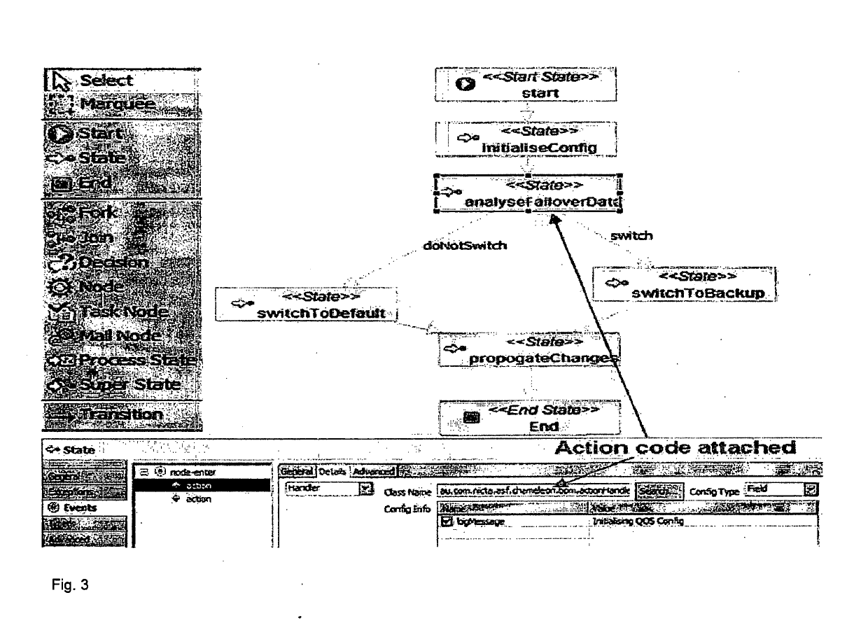

FIG. 3 shows a sample GUI for designing a control model and attaching action code to it. These actions are encapsulated in handlers, and can be executed by a process engine. Such an engine can be embedded at the middleware level. Therefore, the advantage of using process models in modelling controls is that controls can be visually designed and executed. In addition, the integration of the model execution and the middleware is much simplified by the process engine. This approach is similar to that used in tools such as JBoss jBPM, which is a realization of a full-fledged process engine with IDE support to design process models [8].

The component layer 24 aims to address architecture requirement (2). The realization of controls depends on monitoring and actuating components, such as software sensors to collect status data to feed into the model, and effectors to execute actions. These components are placed into the component layer 24 to separate the control implementation from the business logic. The ApplicationManager is responsible for initializing the component instances. As control components participate in service oriented applications, each component has a unique endpoint as its identifier, so that messages can be received from and sent to individual components by service bus middleware.

The control layer 26 aims to fulfil the architecture requirement that controls can be composed, modified and deployed at runtime. Control components are deployed as the unit of the ControlDeploymentPackage. Each control has a default ControlDeploymentPackage generated by the framework. It contains methods to access all the components involved in a control. Each ControlDeploymentPackage. uses the ControlDeployer to deploy its components. The ControlDeployer is responsible for (un)deploying components, creating component descriptors and setting the implementation class for each component. This separated deployment of the component instance from its actual implementation further enhances the customization of the adaptive controls. This is because the modification of the implementation does not impact the control models nor the deployment structure, and the implementation can be updated at any time. Once the deployment is finished, an event is broadcasted to other controls about the availability of the new control components.

The bottom layer is the middleware platform 28. In this example it is a specific Java ESB—Mule [14]. Mule platform specific mechanisms are used to devise utilities such as concurrency configuration and event multicasting.

In summary, the architecture supports visual and declarative design of adaptive control logic. Controls are modelled as executable process models. These models are executed by a dedicated process engine, which is seamlessly integrated with the middleware. Hence these models can interact with service applications hosted by middleware, receiving and sending messages to realize the control logic. In addition, the architecture supports dynamic update and deployment of controls. As a result, the overall architecture is loosely coupled between business logic and adaptive controls. In the following sections, we further discuss the coordination of multiple controls.

### Techniques of Coordinating Controls

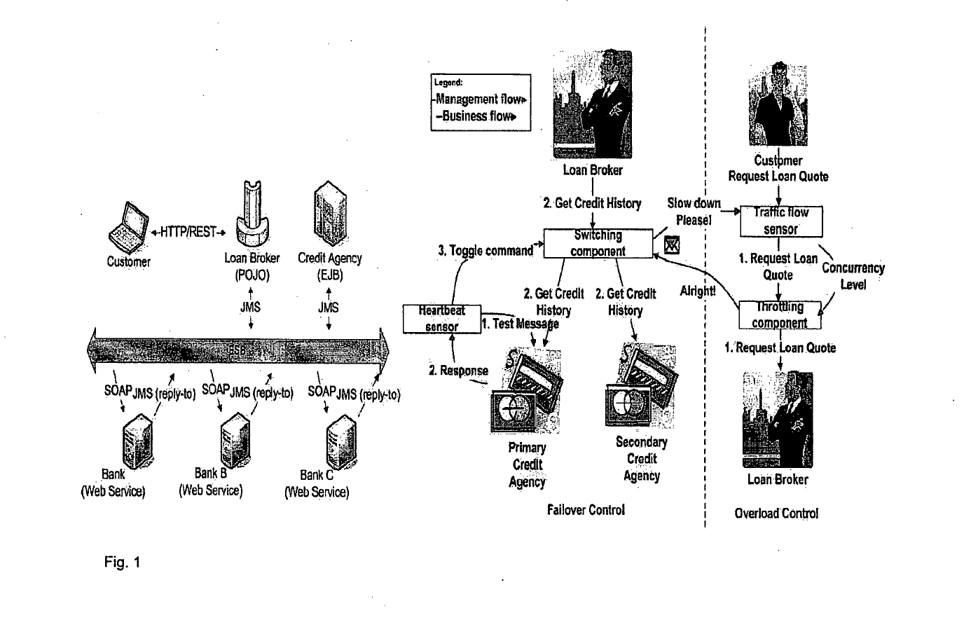

A challenging issue to solve in this architecture is control dependencies occurring at runtime. Controls designed and deployed independently may involve cross-cutting concerns. For example, FIG. 1 illustrates that when the failover control takes place, it requires the collaboration from the overload control to slow down its current processing for the period of time that the failover is being executed.

Our architecture can address this issue by the techniques of modelling such concerns as coordination controls. The components coordinated are the sensors and effectors from individual controls. The dependencies are declared in a control model representing the cross-cutting concern; the specific resolution strategy, be it by heuristic hints or some form of machine learning, consists of implementation specific handlers attached to the process nodes. This leverages on the architecture framework presented, building on the basic idea of sensors, effectors and coordinating components. In the following subsections, we discuss the technical details of achieving such coordination among multiple controls.

### Control Dependencies and Composition

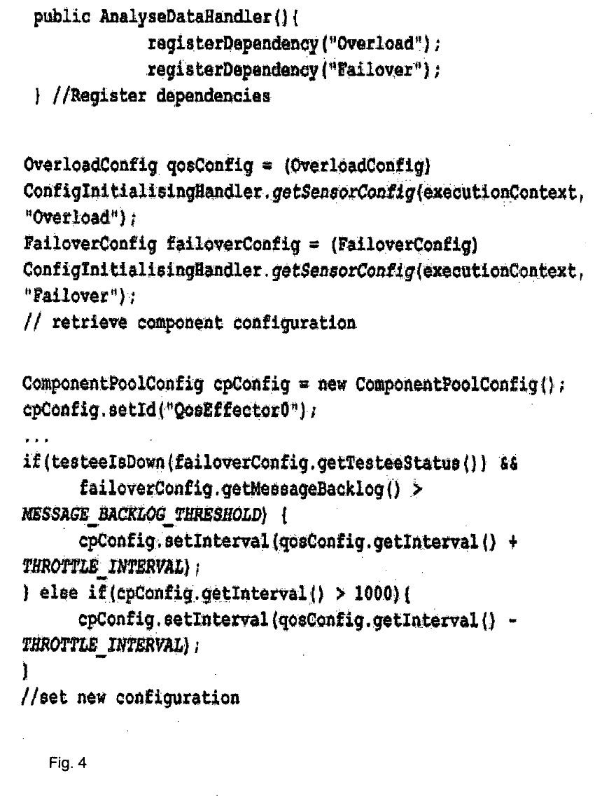

In our approach, the dependencies of controls are declared by developers in a dedicated coordination control, as discussed at the top layer 22 of the architecture. The developer registers controls with dependencies using an AnalysisHandler that belongs to the handler layer. This coordination control is modelled and deployed the same way as ordinary QoS controls. When it is deployed, another handler, a ConfigInitialisingHandler checks if an instance of the registered controls exist. After the ConfigInitialisingHandler checks the controls and their dependencies, the AnalysisHandler can retrieve the configuration of individual components in one control. A configuration is part of the control layer. It is an abstraction of what the component does. A configuration contains information about interfaces and properties of a component. Through the configuration, the coordination control and the AnalysisHandler can access data that the component contains, invoke its interface on behalf of the coordination and change property values in order to change the control parameters. Sample code is shown in FIG. 4.

Using this approach, individual controls are not aware of other controls nor their dependencies. They are transparently managed by coordinating controls. This approach also benefits from the architecture in that a coordination control can flexibly be composed by existing components, which allows quick composition and prototyping of alternative options for adaptive and self-management strategies. An example of composing coordination controls is given below. In addition, coordination controls can be updated, deployed or undeployed at runtime. This equips developers with the flexibility to trial-and-test different designs.

### Control Deployment

The deployment of controls takes two steps. First, the control design models in the format of an XML file are deployed to the process engine using an IDE shipped with the process engine. Any action code is attached to the states or transitions in this model. Second, the unit of deployment ControlDeploymentPackage in our architecture framework is generated, with a mapping to the component implementation record. Following this, the ControlDeploymentPackage invokes the deploy( ) method of ControlDeployer to deploy itself, creating instances of participating components using their descriptors.

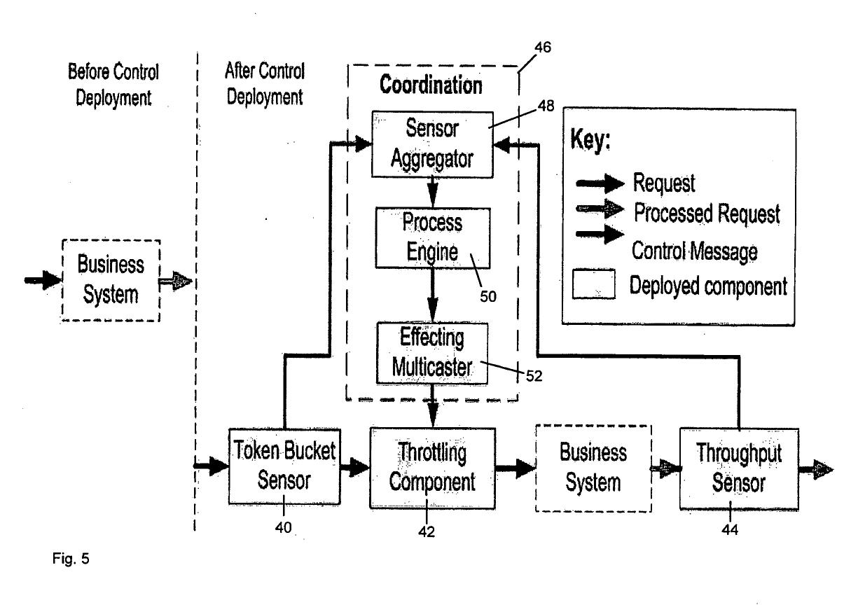

Besides the above functionality of deployment, the architecture requires the ability to intercept incoming requests, and modify outgoing messages. This is also achieved through the control deployment. The control deployment automatically generates intercepting components as a proxy to the intercepted components. The intercepting component takes the identity—the unique endpoint of the intercepted component and forwards requests to and replies from the intercepted components. This feature enables the control composition by redirecting messages to/from any other component transparently to the intercepted components. FIG. 5 depicts components before and after the deployment of the overload control. Details of this control are discussed in below.

### Quality Attributes and Optimization

The computing overhead incurred by this architecture should be optimized. By nature of this service oriented architecture, the optimization problem falls into the category of minimizing messaging overhead. Research on messaging oriented middleware and Web services has demonstrated that the communication rate and payload of the messages have a significant impact on the overall performance and scalability of SOAs [10]. Hence our optimization focuses on reducing the number of messages and their payload with regards to sending collected data among control components including sensors, data analysers and effectors. Rather than wrapping data as a SOAP attachment, data collected by sensors are stored in a distributed cache. Whenever necessary, a distributed cache is attached with the control components such as software sensors. In this case, we select an open source distributed cache framework—Ehcache [13]. The performance and scalability of Ehcache has proven to satisfy large scale distributed systems [5]. In order to correlate data collected from different sensors, a sensor aggregation component is created at deployment time. Here, a default time-based correlation is implemented in the aggregator. The only limitation with using a distributed cache is that the data transition is separated from the web service messages and it is specific to the distributed cache framework.

### DETAILED EXAMPLE

A more detailed example will now be described using the loan brokering services discussed in the Background Art section. In addition to verifying the feasibility of our architecture in implementing a practical set of services, we also highlight the flexibility of our architecture for trial-and-test deployments by providing two options to coordinate the failover and overload controls, subsequently referred to as simple and auction-based coordination. Here, we discuss the specifics of the individual components making up our implementation, as well as two coordination heuristics employed.

### Overload Control

The overload control implements the classic token-bucket algorithm for admission control. It consists of a Token Bucket Sensor 40, a Throttling Component 42, a Throughput Sensor 44 and a Coordination Component 46, as shown in FIG. 5. The Token Bucket Sensor 40 maintains a token bucket with χ tokens, where a single token is used for each request. If no tokens are available, the request is dropped and does not enter the system. The token bucket is refilled at rate λ. The Throttling Component 42 controls W, the number of concurrent requests that can be processed. Each processed request is delayed by a throttling interval I. The Throughput Sensor 44 measures δ, the rate of requests being processed by the system. Finally, the Coordination Component 46 constantly aggregates 48 the throughput δ and the number of tokens left in the token bucket. It then feeds the status to the control model in the process engine 50, and multicasts 52 to effectors 42 and 40 the decision on the new values of λ, W and I accordingly. The adjustment of λ is given by:

$$α * \frac{W}{I} + ( 1 - α ) * δ$$

where α is a tuning parameter to adjust the component weight.

### Failover Control

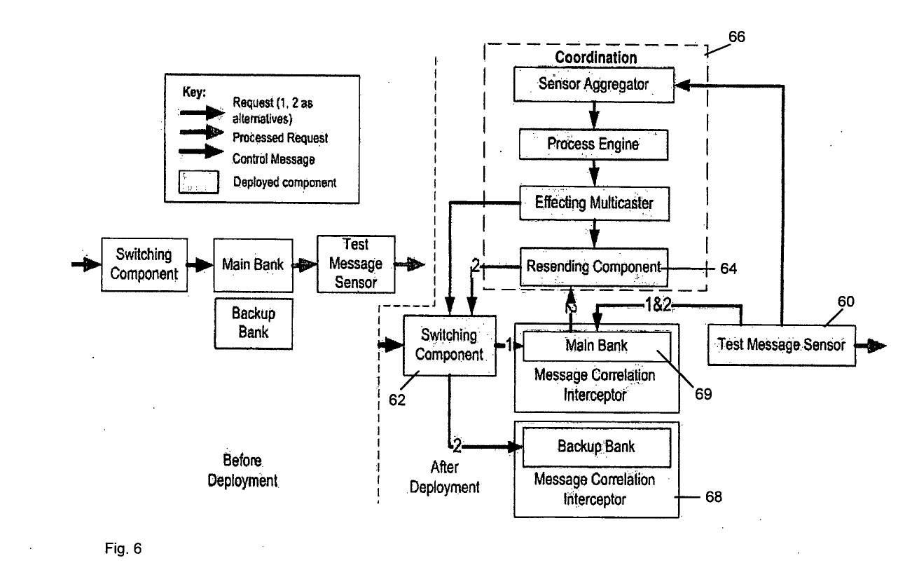

The failover control shown in FIG. 6 consists of a Test Message Sensor 60, a Switching Component 62, a Resending Component 64 and a Coordination Component 66. The Test Message Sensor 60 constantly sends test messages to the main service. It uses the test messages to determine if the main service is active or has failed. The Coordination Component 66 constantly receives inputs from the Test Message Sensor 60 and adjusts the state of the Switching Component 62 (on or off). If the main service has failed, the Switching Component 62 routes incoming requests to the active service when its state is toggled to on by the Coordination Component 66. A Message Correlation Interceptor 68 maintains a queue of messages by intercepting incoming requests to the main service. When a request is successfully routed, the request is removed from the queue. The Resending Component 64 sends unprocessed requests from the Message Correlation Interceptor 68 to the active services 69 when the Switching Component 62 is toggled.

### Coordinating Multiple Controls

To coordinate these controls, our general approach is to let the overload control throttle the workload when failover takes place. In our implementation, two options are provided to realise this approach.

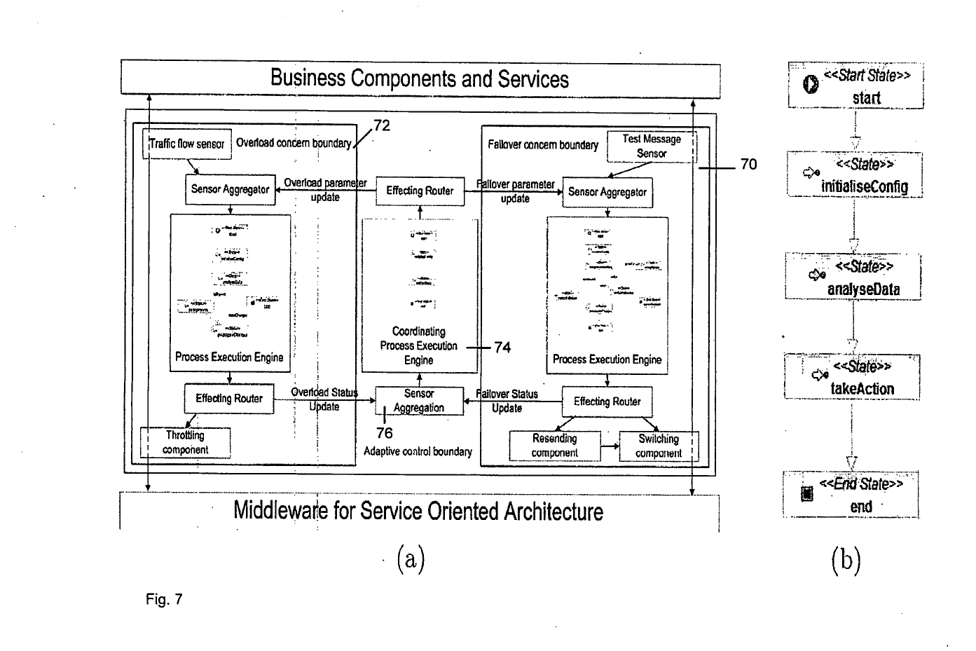

Our implementation of the architecture is deployed as shown in FIG. 7(a), which also shows the failover 70 and overload 72 quality controls employed. The core of the coordination is the coordination control model 74 shown in FIG. 7(b). This was created using the JBoss jBPM process model designer. As both Coordination Components multicast their status data, the coordination between these two controls collects updated status data from each control using its SensorAggregator 76 and sends out action decisions through the EffectingRouter 78. Handlers are attached to nodes and transitions to realize the two control options: (1) simple coordination and (2) auction-based coordination.

The simple coordination control tunes the concurrency level of processing new, incoming requests in the middleware. The tuning is based on the number of messages yet to be resent by the failover control. This control is easier to implement, but has limitations when producing the optimal concurrency levels for a large set of services.

In the auction-based control, requests being resent by the failover control and new incoming requests at the overload control bid for tokens. Tokens are dynamically allocated to requests both from failover and overload controls. Only requests with a token can be processed, otherwise there is a wait for the next available token. In general, the auction-based control incurs more overhead in communication as a bid is multicast. However, the auction-based control is more practical and suitable when it is nontrivial to tune the concurrency level of the middleware.

Both options reuse the failover and overload controls, and it should be noted that the control model is identical for both options. The difference is in the way each of them process status data and the actions taken. This is reflected by the different options having different handlers attached to the appropriate control model nodes.

In this example, process modelling tools and middleware mechanisms are used to customize the general architecture to a specific implementation. As mechanisms from middleware (such as interceptors) and modelling features from the process engine (such as handlers) are commonly supported, other process modelling tools and service bus middleware can be applied to the framework. The only condition however, is that the process engine should be able to communicate with the middleware. For example, Mule provides a common interface for process engines to access its features [14]. We could have used an Oracle BPM implementation of the interface instead of JBoss jBPM, without any change to other implemented components. This illustrates the generic nature of our architectural solution.

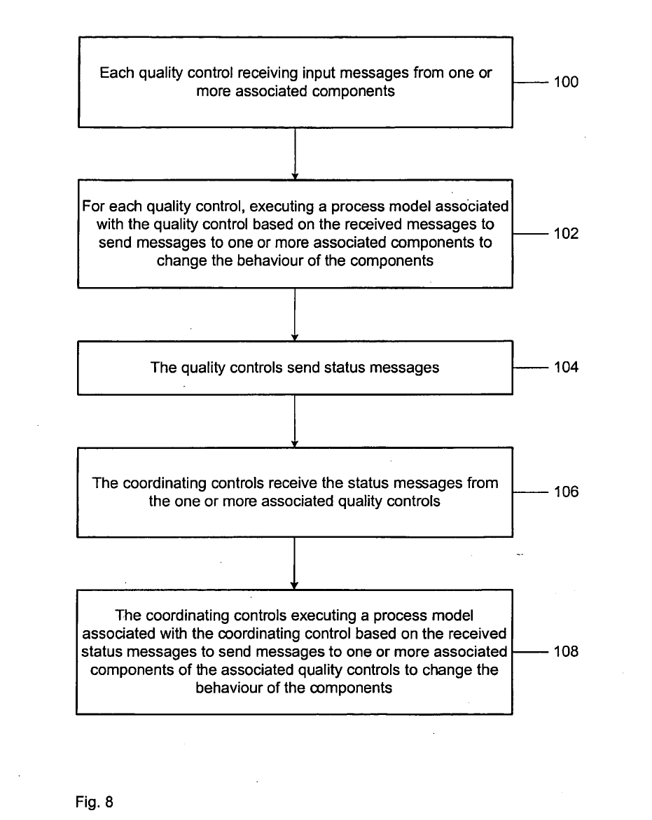

In use the quality control 70 and 72 and the coordinating control 74 operate according to the method shown in FIG. 8.

The quality controls 70 and 72 receive input messages from one or more associated components (i.e. sensor aggregator), step 100. Then the quality controls 70 and 72 execute their respective process models based on the received messages to send messages to the one or more associated components (i.e. throttling component and effecting router) to change the behaviour of the components, step 102.

Optionally, the quality controls 70 and 72 send status messages, step 104. The coordinating control 74 receives status messages from the one or more associated quality controls 70 and 72, step 106. Then the coordinating control 74 executes its process model based on the received status messages to send messages to the one or more associated components (i.e. effecting router associated with the coordinating control and then inturn the sensor aggregators associated with the quality controls 70 and 72), step 108.

Each option of the coordination control is measured and the results are compared to identify key performance factors.

We deploy the loan brokering services as shown in FIG. 1 on the Mule ESB. The credit agency services are developed as Java EJBs and deployed on a JBoss application server. Bank services are Web services deployed on Apache Tomcat servers. The brokering service is a Mule application, and it communicates with other services through Mule. The adaptive controls (failover and overload) are designed using JBoss jBPM and their models are deployed into the jBPM engine. The handlers and control components are built upon the architecture framework discussed in Section 3 using Java. Together with the process engine, the models and components are deployed on Mule.

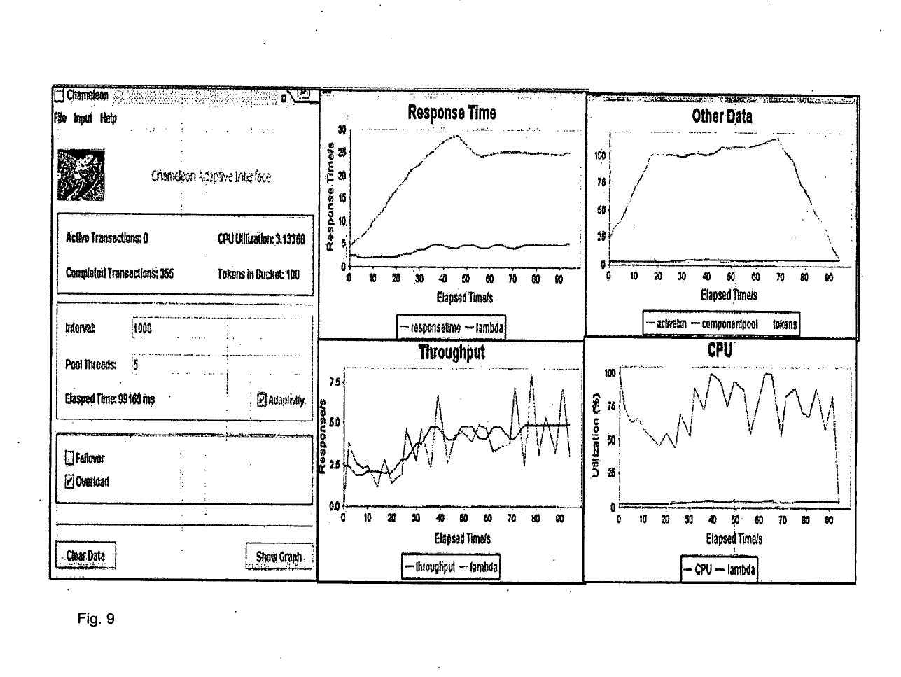

We also develop a simple workload generator which injects a number of requests into the system under test with a bounded random time between request arrivals. For example, the interval [75,200] means the request arrival time bound is between 75 to 200 milliseconds. In order to observe performance, a simple console showing charts of metrics was developed (see FIG. 9 for example that was developed using an open source library jFreechart).

The testing environment includes two identical Windows XP machines with 2.4 GHz Dual Xeon Processors, one hosting loan broker services, credit agencies and adaptive controls and the other hosting five bank services which are identical to simplify implementation. The workload generated is a set of 500 requests with the interval [75,225]. If the overload control is enabled, the throttling component controls W, the number of concurrent requests that can be processed. W is set to 100 initially.

We test four scenarios: (1) only the overload control is enabled; (2) only the fail over control is enabled; (3) simple coordination; and (4) auction-based coordination. Obviously in (3) and (4) both failover and overload controls are enabled. The same environment configurations are used for each test. FIG. 9 to FIG. 12 show sample performance measurements from the testing scenarios.

FIG. 9 shows that the overload control is efficient in self-management of performance and scalability. It is shown on the other data chart (top right of FIG. 9) that after approximately 20s has elapsed, the token number hits zero, meaning there are already 100 requests being processed. From the CPU chart, it shows that the CPU utilization starts increasing and it triggers the overload control before 40s elapsed time. The response time chart illustrates that the overload control takes effect around 45s elapsed time, and the response time reaches a plateau rather than continuing to increase linearly.

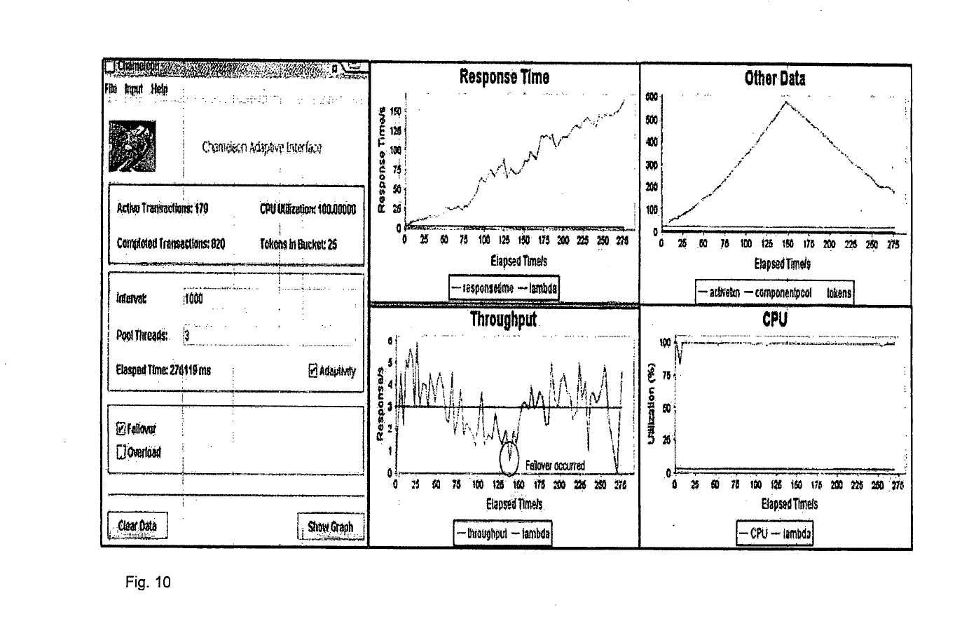

FIG. 10 shows the failover control in operation. At around elapsed time 140s, the primary credit agency service is deliberately shut down, and the requests are routed by the failover control to the secondary credit agency service. This is consistent with the other data chart that shows the active transactions reach the peak at around elapsed time 140s, and then degrade when the failover occurs. The CPU resource is saturated without the overloading control and the response time increases. These separated performance testing scenarios confirm the motivation for coordinating two controls to yield a better quality of service. The results from a single control indicate that the overhead of the architecture framework itself is insignificant, and the performance factors are determined by the adaptive self-managing strategies.

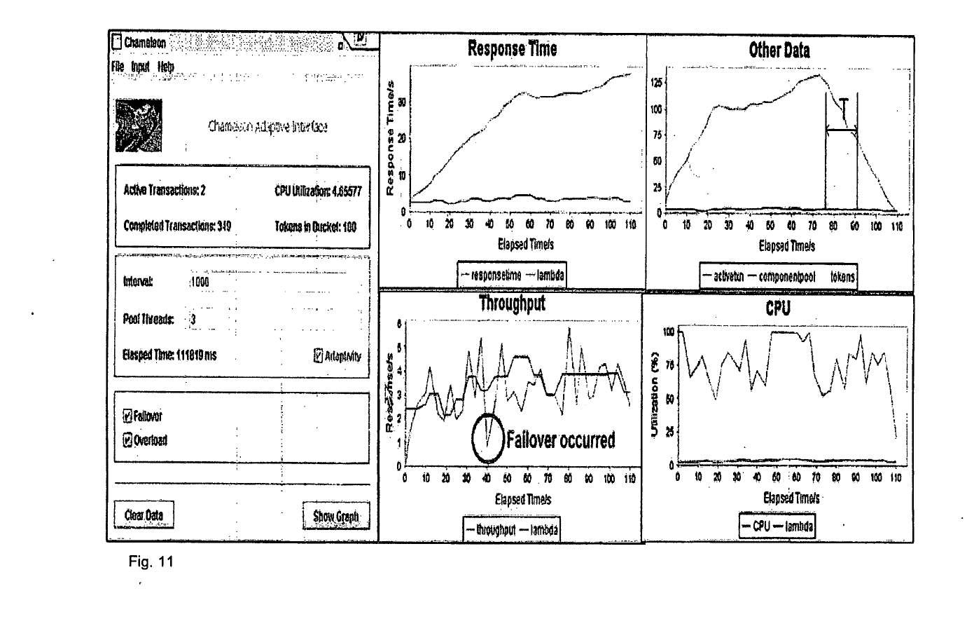

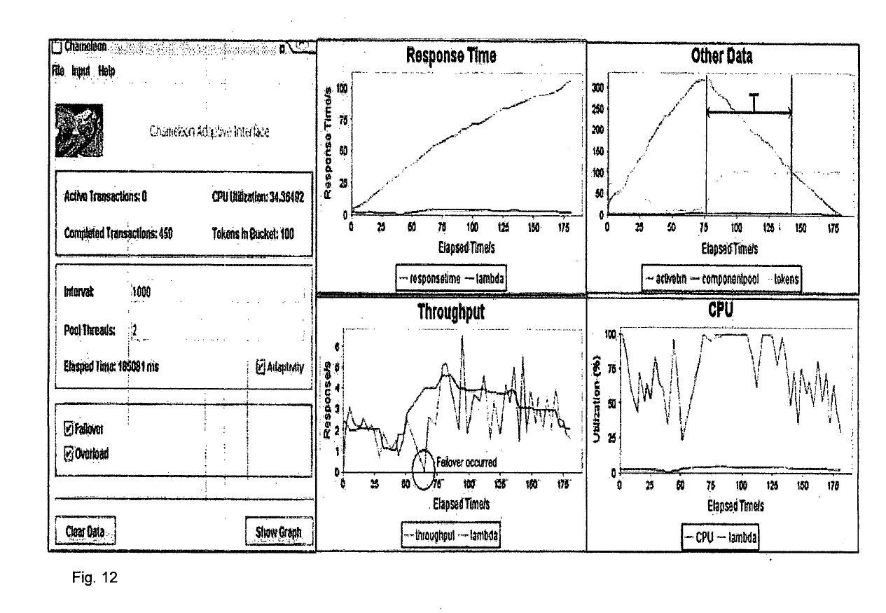

Coordination can be enabled or disabled. The results of the simple coordination are shown in FIG. 11. Compared with the case of failover control only, when enabled the coordination helps to improve the performance. Coordination can be automatically enabled when all the associated quality controls are also enabled. Now the response times reach the plateau and the CPU utilization is not saturated. From the results of the auction-based coordination shown in FIG. 12, the performance improvement is less than the simple coordination, which we attribute to the additional communication overhead incurred in the auction-based coordination as mentioned above. An interesting observation is the time (annotated as T in the diagrams) spent on processing queued requests. Requests are put in a queue by the overload control when all the tokens are consumed, and are only processed when the token bucket is refilled and more tokens are available. The auction-based coordination took a longer time (T) than the simple option, which contributes to the degradation of performance.

It is worth noting that our focus directly above is not on studying and evaluating individual coordination controls but rather on demonstrating the practical usage of the architecture to compose them.

It will be appreciated by persons skilled in the art that numerous variations and/or modifications may be made to the invention as shown in the specific embodiments without departing from the scope of the invention as broadly described.

For example, the invention could be implemented in a cloud computing environment. The emerging trend is deploying services on Cloud so that software (i.e. Salesforce.com for customer-relationship-management) and platforms (i.e. Amazon Elastic Computing) can be encapsulated as services to support pervasive and on-demand usage.

The present embodiments are, therefore, to be considered in all respects as illustrative and not restrictive.

### REFERENCES

1. van der Aalst, W. M.: Business process management demystified: A tutorial on models, systems and standards for workflow management. In: Lectures on Concurrency and Petri Nets, pp. 1-65 (2004)
2. Baresi, L., Guinea, S., Pasquale, L.: Self-healing bpel processes with dynamo and the jboss rule engine. In: ESSPE 2007: International workshop on Engineering of software services for pervasive environments, pp. 11-20. ACM, New York (2007)
3. McKinley, P. K., Sadjadi, S. M., Kasten, E. P., Cheng, B. H. C.: Composing adaptive software. Computer 37(7), 5&-64 (2004)
4. Naccache, H., Gannod, G. C.: A self-healing framework for web services. Icws 00, 34&-398 (2007)
5. Gorton, l., Wynne, A., Almquist, J., Chatterton, J.: The MeDICi Integration Framework: A Platform for High Performance Data Streaming Applications. In: WICSA 2008: 7th Working IEEE/IFIP Conference on Software Architecture, pp. 95-104. IEEE Computer Society, Los Alamitos (2008)
6. Hohpe, G., Woolf, B.: Enterprise Integration Patterns: Designing, Building, and Deploying Messaging Solutions. Addison-Wesley Professional, Reading (2003)
7. IBM. An architectural blueprint for autonomic computing. IBM Autonomic Computing (2004)
8. JBoss jBPM, http://www.jboss.com/products/jbpm
9. Foster, H., Uchitel, S., Magee, J., Kramer, J.: Tool Support for Model-Based Engineering of Web Service Compositions. In: Proc. of Intl. Conf. on Web Services (ICWS 2005), pp. 95-102. IEEE Computer Society, Los Alamitos (2005)
10. Juse, K., Kounev, S., Buchmann, A.: PetStore-WS Measuring the Performance Implications of Web Services. In: CMG 2003: Proc. of the 29th International Conference of the Computer Measurement Group (2003)
11. Kephart, J. O.: Research challenges of autonomic computing. In: ICSE 2005: Proceedings of the 27th international conference on Software engineering, pp. 15-22. ACM, New York (2005)
12. Kramer, J., Magee, J.: Self-managed systems: an architectural challenge. In: FOSE 2007: 2007 Future of Software Engineering, pp. 259-268. IEEE Computer Society, Los Alamitos (2007)
13. Luck, G., Suravarapu, S., King, G., Talevi, M.: EHCache Distributed Cache System, http://ehcache.sourceforge.net/
14. Mule ESB, http://mule.mulesource.org/
15. P. M., et al.: The wsdm of autonomic computing: Experiences in implementing autonomic web services. In: SEAMS 2007: Proceedings of the 2007 International Workshop on Software Engineering for Adaptive and Self-Managing Systems, p. 9. IEEE Computer Society, Los Alamitos (2007) p0 16. Anthony, R. J.: Policy-based techniques for self-managing parallel applications. Knowl. Eng. Rev. 21(3), 20&-219 (2006)
17. Kumar, V., Cooper, B. F., Eisenhauer, G., Schwan, K.: Enabling policy-driven self-management for enterprise-scale systems. In: HotAC II: Hot Topics in Autonomic Computing on Hot Topics in Autonomic Computing, pp. 4-23. VSENIX Association (2007)
18. Verma, K., Sheth, A. P.: Autonomic Web Processes. LNCS. Springer, Heidelberg (2005)
19. Zhu, L., Osterweil, L., Staples, M., Kannengiesser, V., Simidchieva, B.: Desiderata for languages to be used in the definition of reference business processes. International Journal of Software and Informatics 1, 37-65 (2007)

1. A service orientated computer system comprised of services connected by an event-driven message based middleware, the middleware further comprising:
multiple components that function to sense messages and effect delivery of messages within the middleware and between services;
a set of controls to automatically change the behaviour of the system to meet a quality of service, the set of controls comprising:
multiple quality controls each directed to one or more quality of service metrics and associated with one or more components, where each quality control is modelled as an executable process model that receives input messages from one or more associated components and, based on the received messages and the executable process model, operates to automatically send messages to the one or more associated components to change the behaviour of the one or more associated components; and
a process engine to execute the executable process models of the controls.

2. A service orientated computer system according to claim 1, wherein the model of the quality control is comprised of states and transitions having associated action code that when executed by the process engine changes the behaviour of the one or more associated components.

3. A service orientated computer system according to claim 1, wherein one or more components have control parameters and the message sent to a component alters a control parameter of the component.

4. A service orientated computer system according to claim 1, wherein the set of controls further comprises:
one or more coordinating controls that are associated with one or more quality controls, where each coordinating control is modelled as an executable process model to automatically coordinate dependencies between the two or more associated quality controls.

5. A service orientated computer system according to claim 4, wherein the coordinating controls receive status messages from each of the associated quality controls and coordinates dependencies between these quality controls based on the received status messages and executable process model. The status messages may be received by an aggregation sensor component of the coordination control.

6. A service orientated computer system according to claim 4, wherein the coordination control operates to change the behaviour of the system by sending a message to a component associated with a quality control that is in turn associated with the coordination control in order to change the behaviour of the one or more associated components.

7. A service orientated computer system according to claim 6, wherein the message sent from a coordination control to a component has precedence over a message sent from a quality control to the same component.

8. A service orientated computer system according to claim 5, wherein a first quality control is directed to overloading as the quality of service metric and a second quality control is directed to failover as the quality of service metric.

9. A service orientated computer system according to claim 8, wherein the coordinating control is associated with the first and second quality control, and the coordinating control receives the status message from the second quality control indicating that overload has occurred and then automatically sends a message to a component associated with the overload control to cause the slowing down the acceptance rate of new requests to a service until the failover operations complete.

10. A service orientated computer system according to claim 1, wherein the components are sensors, routers, throttlers and/or multicasters.

11. A service orientated computer system according to claim 1, wherein the models are in business process modelling (BPM) language.

12. A service orientated computer system according to claim 1, wherein each coordinating control represents a unique cross cutting concern of the associated quality controls.

13. A service orientated computer system according to claim 1, wherein the services are spread across multiple organization boundaries and the components, controls and processing engine are deployed at service boundary.

14. A service orientated computer system according to claim 1, wherein the event-driven middleware includes an Enterprise Service Bus (ESB).

15. A service orientated computer system according to claim 1, wherein the services are hosted on a distributed computer network or on Internet where any host operates using a Cloud platform.

16. A service orientated computer system according to claim 1, wherein services are web based, and are accessed by a unique identity.

17. A method of automatically changing the behaviour a service orientated computer system comprised of services connected by an event-driven message based middleware to meet a quality of service, the method comprising executing at run time multiple quality controls, each quality control directed to one or more quality of service metrics and associated with one or more components that function to sense messages and effect delivery of messages within the middleware and between services, by each quality control:
receiving input messages from one or more associated components;
executing a process model associated with the quality control based on the received messages to send messages to one or more associated components to change the behaviour of the components.

18. The method according to claim 17, wherein the method further comprises the steps of the quality controls sending status messages and executing at run time coordinating controls that automatically coordinate dependencies between two or more associated quality controls.

19. The method according to claim 18, where coordinating dependencies between two or more associated quality controls comprises each coordinating control:
receiving the status messages from the one or more associated quality controls;
executing a process model associated with the coordinating control based on the received status messages to send messages to one or more associated components of the associated quality controls to change the behaviour of the components.

20. Software, that is computer executable instructions stored on a computer readable medium that when installed causes a computer system to perform the method of claim 17.
